(19) United States
(12) Patent Application Publication
(10) Pub. No.: US 2011/0208914 A1
(43) Pub. Date: Aug. 25, 2011

(54) STORAGE SYSTEM AND METHOD OF OPERATING THEREOF

(75) Inventors: Alex WINOKUR, Haifa (IL); Haim KOPYLOVITZ, Herzliya (IL)

(73) Assignee: INFINIDAT LTD., Herzliya (IL)

(21) Appl. No.: 13/032,158

(22) Filed: Feb. 22, 2011

Related U.S. Application Data
(63) Continuation of application No. PCT/IL2009/000818, filed on Aug. 20, 2009.
(60) Provisional application No. 61/189,755, filed on Aug. 21, 2008.

(51) Int. Cl. G06F 12/08

(52) U.S. Cl. 711/119; 711/E12.017

(57) ABSTRACT

There are provided a storage system, storage control unit and method of operating thereof. A storage system comprises a permanent storage subsystem comprising a first cache memory and a non-volatile storage medium, and a storage control unit operatively coupled to said subsystem and to a second cache memory operable to cache “dirty” data pending to be written to the permanent storage subsystem and to enable, responsive to at least one command by the control storage unit, destaging said “dirty” data or part thereof to the permanent storage subsystem. The storage control unit is operable to determine achievement of a “writing criterion”, to provide, upon achieving, at least one command to the permanent storage subsystem requiring flushing destaged data or part thereof from the first cache memory to the non-volatile storage medium, and to provide at least one command to the second cache memory requiring reclassification of the “washed” data or a respective part thereof into the “clean” data, wherein the storage control unit is further operable to configure the “writing criterion” responsive to indicating one or more predefined events during an operation of the storage system.

### CROSS-REFERENCES TO RELATED APPLICATIONS

This application is continuation of International Application WO2010/020992 claiming priority from U.S. Provisional Patent Application No. 61/189,755, filed on Aug. 21, 2008, both applications incorporated herein by reference in their entirety.

### FIELD OF THE INVENTION

The present invention relates, in general, to data storage systems and methods for data storage, and, more particularly, to cache-comprising data storage systems.

### BACKGROUND OF THE INVENTION

In many modern computer applications, the integrity of data is of great importance and cannot be compromised even in case of an emergency shutdown or other failure within the computer system.

In a typical computer system host processors are operatively coupled to one or more permanent storage subsystems via a storage protocol. A host processor may process a transaction by reading relevant data, performing calculations thereon, and writing the results back. The data may be stored at the permanent storage subsystem(s), wherein the process of transferring data to and from the permanent storage subsystem(s) typically includes temporarily storing data and/or metadata in a volatile cache memory (data and/or metadata stored in a cache memory are referred to hereinafter as “data”). Caching is employed by many computer systems for improving input/output (I/O) performance between the storage subsystem(s) and the host(s). In addition, the cache memory may be used to improve internal storage system operations such as error logging, recovery, reconstruction, etc. However, at the time of a power failure any transactions in progress and respective data temporarily stored in the volatile cache may be lost, and the integrity of data may be compromised.

The problem of retaining data in cache-comprising computer systems even when external power to the system is interrupted has been recognized in the Prior Art and various systems have been developed to provide a solution, for example:

US Patent application No. 2004/49638 (Ashmore et al.) entitled “Method for data retention in a data cache and data storage system” discloses a method and a system for data retention in a data cache. The data storage system includes a storage controller with a cache and a data storage means. The cache has a first least recently used list for referencing dirty data which is stored in the cache, and a second least recently used list for clean data in the cache. Dirty data is destaged from the cache when it reaches the tail of the first least recently used list and clean data is purged from the cache when it reaches the tail of the second least recently used list.

US Patent Application 2006/212644 (Lee et al.) entitled “Non-volatile backup for data cache” discloses a non-volatile data cache having a cache memory coupled to an external power source and operable to cache data of an external data device such that access requests for the data can be serviced by the cache rather than the external device. A non-volatile data storage device is coupled to the cache memory. An uninterruptible power supply (UPS) is coupled to the cache memory and the non-volatile data storage device so as to maintain the cache memory and the non-volatile storage device in an operational state for a period of time in the event of an interruption in the external power source.

US Patent Application No. 2008/189484 (Ilda et al.) entitled “Storage control unit and data management method” discloses an I/O processor configured to determine whether or not the amount of dirty data on a cache memory exceeds a threshold value and, if the determination is that this threshold value has been exceeded, to write a portion of the dirty data of the cache memory to a storage device. If a power source monitoring and control unit detects a voltage abnormality of the supplied power, the power monitoring and control unit maintains supply of power using power from a battery, so that a processor receives a supply of power from the battery and saves the dirty data stored on the cache memory to a non-volatile memory.

US Patent Application No. 2008/276040 (Moritoki) entitled “Storage apparatus and data management method in storage apparatus” discloses a system and method capable of preventing the loss of data retained in a volatile cache memory even during an unexpected power shutdown. This storage apparatus includes a cache memory configured from a volatile and nonvolatile memory. The volatile cache memory caches data according to a write request from a host system and data staged from a disk drive, and the nonvolatile cache memory only caches data staged from a disk drive. Upon an unexpected power shutdown, the storage apparatus immediately backs up the dirty data and other information cached in the volatile cache memory to the nonvolatile cache memory.

US Patent Application 2009/077312 (Miura) entitled “Storage apparatus and data management method in the storage apparatus” discloses a storage apparatus setting up part of non-volatile cache memory as a cache-resident area. In an emergency such as an unexpected power shutdown, the storage apparatus backs up dirty data of data cached in volatile memory to an area other than the cache-resident area in the non-volatile cache memory, together with the relevant cache management information. Further, the storage apparatus monitors the amount of the dirty data in the volatile cache memory so that the dirty data cached in the volatile cache memory is reliably contained in a backup area in the non-volatile memory, and when the dirty data amount exceeds a predetermined threshold value, the storage apparatus releases the cache-resident area to serve as the backup area.

### SUMMARY OF THE INVENTION

In accordance with certain aspects of the present invention, there is provided a storage system comprising a) a permanent storage subsystem comprising an internal cache memory and a non-volatile storage medium and b) a storage control unit operatively coupled to said subsystem and to a volatile cache memory operable to cache “dirty” data pending to be written to the permanent storage subsystem and to enable, responsive to at least one command by the control storage unit, destaging said “dirty” data or part thereof to the permanent storage subsystem. The volatile cache memory is further operable to cache data destaged to the permanent storage subsystem whilst keeping this data as non-erasable thus giving rise to “washed” data, and, responsive to at least one command by the storage control unit, to facilitate reclassification of the “washed” data or part thereof into erasable data thus giving rise to “clean” data. The storage control unit is further operable to determine achievement of a “writing criterion”, to provide, upon achieving, at least one command to the permanent storage subsystem requiring flushing destaged data or part thereof from the internal cache memory to the non-volatile storage medium, and to provide at least one command to the volatile cache memory requiring reclassification of the “washed” data or a respective part thereof into the “clean” data.

In accordance with further aspects of the present invention, the storage system may further comprise a non-volatile data storage unit external to the permanent storage subsystem and operatively coupled to the volatile cache memory, and an uninterruptible power supply (UPS) operatively coupled to the storage control unit and to said non-volatile data storage unit so as to maintain the volatile cache memory, the storage control unit and the non-volatile storage unit in an operational state for a period of time in the event of a power failure. The storage control unit may be further operable to enable storing “dirty” data and “washed” data in the non-volatile data storage unit in the event of a power failure thus giving rise to “saved” data. Upon the power recovering, the storage control unit may be operable to enable retrieving said “saved” data from the non-volatile data storage unit to the volatile cache memory, classifying said “saved” data as “dirty” data, and further destaging said data to the permanent storage subsystem.

In accordance with further aspects of the present invention, the “writing criterion” may comprise at least one sub-criterion with respect to data destaged to a certain part of the permanent storage subsystem, and the storage control unit is further operable to provide, upon achieving said sub-criterion, at least one command to the permanent storage subsystem requiring flushing data destaged to said certain part of the permanent storage subsystem, and to provide at least one command to the volatile cache memory requiring reclassification of a portion of “washed” data into the “clean” data, said portion corresponding to data destaged to said certain part of the permanent storage subsystem.

In accordance with other aspects of the present invention, there is provided a storage control unit operable to control I/O operations to a permanent storage subsystem comprising an internal cache memory and a non-volatile storage medium. The storage control unit may comprise a volatile cache memory operable or be operatively coupled to such memory. The volatile cache memory is operable to cache “dirty” data pending to be written to the permanent storage subsystem and to enable, responsive to at least one command by the control storage unit, destaging said “dirty” data or part thereof to the permanent storage subsystem. The volatile cache memory is further operable to cache data destaged to the permanent storage subsystem whilst keeping this data as non-erasable thus giving rise to “washed” data, and, responsive to at least one command by the storage control unit, to facilitate reclassification of said “washed” data or part thereof into erasable data thus giving rise to “clean” data. The storage control unit is further operable to determine achievement of a “writing criterion”, to provide, upon achieving, at least one command to the permanent storage subsystem requiring flushing destaged data or part thereof from the internal cache memory to the non-volatile storage medium, and to provide at least one command to the volatile cache memory requiring reclassification of the “washed” data or respective part thereof into the “clean” data.

In accordance with further aspects of the present invention, the storage control unit may be further operatively coupled to an uninterruptible power supply (UPS) and may comprise a non-volatile data storage unit operatively coupled to the volatile cache memory. The storage control unit is further operable to enable storing “dirty” data and “washed” data in the non-volatile data storage unit in the event of a power failure thus giving rise to “saved” data. Upon the power recovering, the storage control unit is further operable to enable retrieving said “saved” data from the non-volatile data storage unit to the volatile cache memory, classifying said “saved” data as “dirty” data, and further destaging said data to the permanent storage subsystem.

In accordance with other aspects of the present invention, there is provided a volatile cache memory operable responsive to commands by a storage control unit and adapted as follows: (a) to cache “dirty” data pending to be written to a permanent storage subsystem operatively coupled to the cache memory; (b) to enable, responsive to at least one command by the control storage unit, destaging said “dirty” data or part thereof to the permanent storage subsystem; (c) to cache data destaged to the permanent storage subsystem whilst keeping this data as non-erasable thus giving rise to “washed” data; and (d) responsive to at least one command by the storage control unit, to facilitate reclassification of the “washed” data or a respective part thereof into erasable data thus giving rise to “clean” data.

In accordance with further aspects of the present invention, the volatile cache memory may be operatively coupled to an uninterruptible power supply (UPS) and to a non-volatile data storage unit. The volatile cache memory may be further operable to enable, responsive to at least one command by the storage control unit, storing “dirty” data and “washed” data in the non-volatile data storage unit in the event of a power failure thus giving rise to “saved” data. The volatile cache memory may be further operable to enable, responsive to at least one command by the storage control unit, retrieving said “saved” data from the non-volatile data storage unit, classifying said “saved” data as “dirty” data, and further destaging said data to the permanent storage subsystem.

In accordance with other aspects of the present invention, there is provided a method of operating a storage system comprising a permanent storage subsystem with an internal cache memory and a non-volatile storage medium, a storage control unit and a volatile cache memory. The method comprises: (a) caching in the volatile cache memory “dirty” data pending to be written to the permanent storage subsystem; (b) destaging “dirty” data or part thereof from the volatile cache memory to the permanent storage subsystem, (c) storing the data destaged to the permanent storage subsystem also in the volatile cache memory whilst keeping this data as non-erasable, thus giving rise to “washed” data; (d) determining achievement of a “writing criterion”; (e) responsive to achieving the “writing criterion”, flushing destaged data or part thereof from the internal cache memory to the non-volatile storage medium; and (0 reclassifying respective “washed” data stored in the volatile cache memory into erasable data.

In accordance with further aspects of the present invention, the method may further comprise storing, in the event of a power failure, “dirty” data and “washed” data in a non-volatile data storage unit external to the permanent storage subsystem and operatively coupled to the volatile cache memory, thus giving rise to “saved” data. Further, the method may comprise retrieving, upon power recovery, said “saved” data from the non-volatile data storage unit to the volatile cache memory, classifying said “saved” data as “dirty” data, and further destaging said data to the permanent storage subsystem.

In accordance with other aspects of the present invention, there is provided a method of operating a storage control unit comprising a volatile cache memory and adapted to control I/O operations to a permanent storage subsystem comprising an internal cache memory and a non-volatile storage medium. The method comprises: (a) caching in the volatile cache memory “dirty” data pending to be written to the permanent storage subsystem; (b) enabling destaging “dirty” data or part thereof from the volatile cache memory to the permanent storage subsystem, (c) storing the data destaged to the permanent storage subsystem also in the volatile cache memory whilst keeping this data as non-erasable, thus giving rise to “washed” data; (d) determining achievement of a “writing criterion”; (e) responsive to achieving the “writing criterion”, sending at least one command to the permanent storage subsystem requesting flushing data from the internal cache memory to the non-volatile storage medium; and (f) reclassifying said “washed” data stored in the volatile cache memory into erasable data. The method may further comprise storing, in the event of a power failure, “dirty” data and “washed” data in a non-volatile data storage unit external to the permanent storage subsystem and operatively coupled to the volatile cache memory, thus giving rise to “saved” data. Further the method may comprise retrieving, upon power recovery, said “saved” data from the non-volatile data storage unit to the volatile cache memory, classifying said “saved” data as “dirty” data, and enabling further destaging said data to the permanent storage subsystem.

In accordance with other aspects of the present invention, there is provided a method of operating a volatile cache memory operable responsive to commands by a storage control unit. The method comprises (a) caching “dirty” data pending to be written to a permanent storage subsystem operatively coupled to the volatile cache memory; (b) enabling, responsive to at least one command by the control storage unit, destaging said “dirty” data or part thereof to the permanent storage subsystem; (c) caching data destaged to the permanent storage subsystem whilst keeping this data as non-erasable thus giving rise to “washed” data; and (d) responsive to at least one command by the storage control unit, facilitating reclassification of the “washed” data into erasable data thus giving rise to “clean” data. The method may further comprise enabling storing, in the event of a power failure, “dirty” data and “washed” data in a non-volatile data storage unit external to the permanent storage subsystem and operatively coupled to the volatile cache memory, thus giving rise to “saved” data. The method may further comprise retrieving, upon power recovery, said “saved” data from the non-volatile data storage unit to the volatile cache memory, classifying said “saved” data as “dirty” data, and enabling further destaging said data to the permanent storage subsystem.

In accordance with other: aspects of the present invention, there is provided a storage system comprising (a) a permanent storage subsystem comprising an internal cache memory and a non-volatile storage medium; (b) a storage control unit operatively coupled to said permanent storage subsystem operable to control I/O operations to a permanent storage subsystem; (c) a volatile cache memory operatively coupled to said permanent storage subsystem and operable to cache “dirty” data pending to be written to the permanent storage subsystem, to enable, responsive to at least one command by the control storage unit, destaging said “dirty” data or part thereof to the permanent storage subsystem, and to further cache data destaged to the permanent storage subsystem whilst keeping this data as non-erasable thus giving rise to “washed” data; (d) a non-volatile data storage unit external to the permanent storage subsystem and operatively coupled to the volatile cache memory; and (e) an uninterruptible power supply (UPS) operatively coupled to the storage control unit, to the volatile cache memory and to said non-volatile data storage unit so as to maintain the cache memory, storage control unit and the non-volatile storage unit in an operational state for a period sufficient for writing said “washed” data from said volatile cache memory to said non-volatile data storage unit in the event of a power failure. In the event of a power failure the integrity of data stored in the storage system may be enabled with no back-up powering of the permanent storage subsystem.

In accordance with further aspects of the present invention, the volatile cache memory in the storage system may be further operable, responsive to at least one command by the storage control unit, to facilitate reclassification of the “washed” data or part thereof into erasable data thus giving rise to “clean” data. The storage control unit may be further operable to determine achievement of a “writing criterion”, to provide, upon achieving, at least one command to the permanent storage subsystem requiring flushing destaged data or part thereof from the internal cache memory to the non-volatile storage medium, and to provide at least one command to the volatile cache memory requiring reclassification of the “washed” data or respective part thereof into the “clean” data. The storage control unit may be further operable to enable storing “dirty” data and “washed” data in the non-volatile data storage unit in the event of a power failure thus giving rise to “saved” data. The storage control unit may be further operable to enable, upon the power recovering, retrieving said “saved” data from the non-volatile data storage unit to the volatile cache memory, classifying said “saved” data as “dirty” data, and further destaging said data to the permanent storage subsystem.

In accordance with other aspects of the present invention, there is provided a method of operating a storage system comprising a permanent storage subsystem with an internal cache memory and a non-volatile storage medium, a storage control unit and a volatile cache memory operatively coupled to a non-volatile data storage unit external to the permanent storage subsystem. The method comprises: (a) caching in the volatile cache memory “dirty” data pending to be written to the permanent storage subsystem; (b) destaging “dirty” data or part thereof from the volatile cache memory to the permanent storage subsystem, (c) storing the data destaged to the permanent storage subsystem also in the volatile cache memory whilst keeping this data as non-erasable, thus giving rise to “washed” data; (d) responsive to a power failure event, powering the storage control unit, the volatile cache memory and the non-volatile data storage unit from a back-up power supply; and (e) writing “washed” data and “dirty” data from said volatile cache memory to said non-volatile data storage unit, thus giving rise to “saved” data. Integrity of data stored in the storage system may be provided with no back-up powering for the permanent storage subsystem responsive to a power failure event. The method may further comprise retrieving, upon power recovery, said “saved” data from the non-volatile data storage unit to the volatile cache memory, classifying said “saved” data as “dirty” data, and further destaging said data to the permanent storage subsystem.

Among advantages of certain embodiments of the present invention is providing a cost-effective solution for enabling data integrity in a case of emergency shutdown, and facilitating a mass-data storage system with no need for a battery back-up of a permanent storage media comprising internal cache.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 illustrates a schematic block diagram of an exemplary computer system as known in the art;

FIG. 2 illustrates a generalized flowchart of operating the storage system in accordance with certain embodiments of the present invention; and

FIG. 3 illustrates a schematic block diagram of the storage system in accordance with certain embodiments of the present invention.

### DETAILED DESCRIPTION OF EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, “generating”, “activating”, “reading”, “writing”, “classifying” or the like, refer to the action and/or processes of a computer that manipulate and/or transform data into other data, said data represented as physical, such as electronic, quantities and/or representing the physical objects. The to term “computer” should be expansively construed to cover any kind of electronic device with data processing capabilities, including, by way of non-limiting example, personal computers, servers, computing system, communication devices, storage devices, processors (e.g. digital signal processor (DSP), microcontrollers, field programmable gate array (FPGA), application specific integrated circuit (ASIC), etc.) and other electronic computing devices.

The operations in accordance with the teachings herein may be performed by a computer specially constructed for the desired purposes or by a general purpose computer specially configured for the desired purpose by a computer program stored in a computer readable storage medium.

The term “criterion” used in this patent specification should be expansively construed to include any compound criterion, including, for example, several criteria and/or their logical combinations.

Embodiments of the present invention are not described with reference to any particular programming language. It will be appreciated that a variety of programming languages may be used to implement the teachings of the inventions as described herein.

The references cited in the background teach many principles of cache-comprising storage systems and methods of operating thereof that are applicable to the present invention. Therefore the full contents of these publications are incorporated by reference herein where appropriate for appropriate teachings of additional or alternative details, features and/or technical background.

In the drawings and descriptions, identical reference numerals indicate those components that are common to different embodiments or configurations.

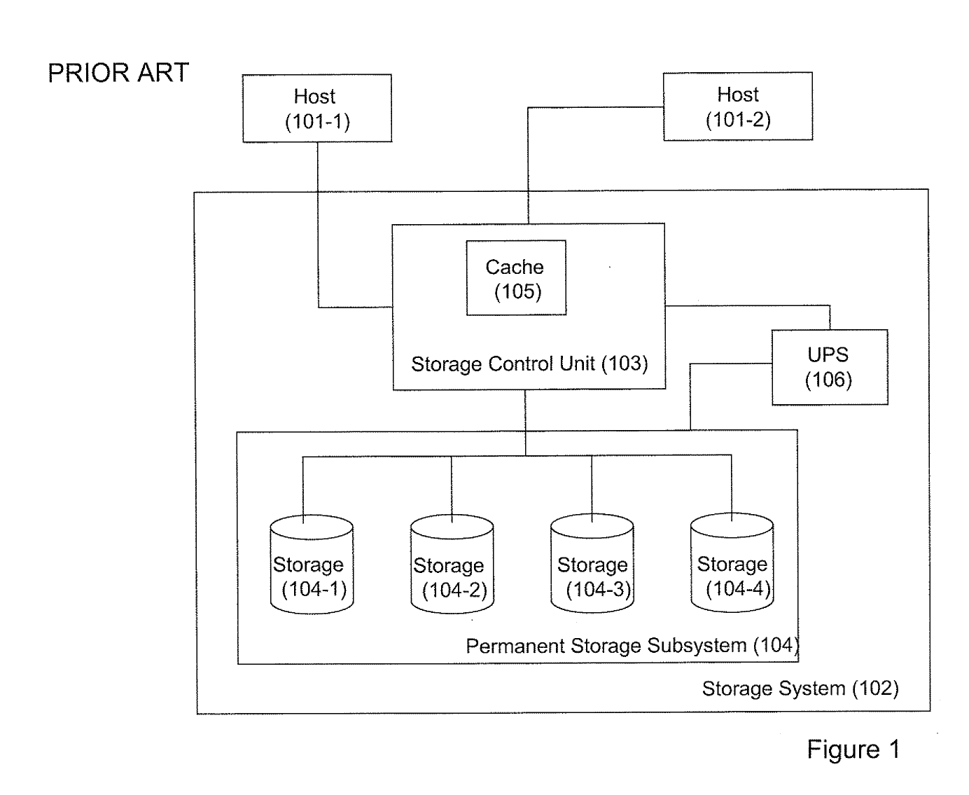

Bearing this in mind, attention is drawn to FIG. 1 illustrating a schematic diagram of an exemplary computer system as known in the art.

The computer system comprises one or more host computers (illustrated as 101-1 and 101-2) sharing common storage means provided by a storage system 102. The storage system comprises a storage control unit 103 operatively coupled to one or more host computers and to a permanent storage subsystem 104 comprising one or more storage devices (e.g. specialized NAS file servers, general purpose file servers, SAN storage, stream storage device, etc.) illustrated as 104-1, 104-2, 104-3 and 104-4. The storage devices may comprise any permanent storage medium, including, by way of example, one or more disk drives and/or one or more arrays of disk drives, and may communicate with the host computers and within the storage system in accordance with any appropriate storage protocol. The storage control unit is configured to control I/O operations between the host computers and the permanent storage subsystem. On receiving a write command from a host computer, the storage control unit 103 enables writing data to at least one storage device of the plurality of storage devices, and, on receiving a read command from the host computer, enables reading data from at least one storage device of the plurality of storage devices and transmitting this data to the host computer.

The storage control unit 103 comprises a volatile cache memory 105 for temporarily storing the data to be written to the storage devices in response to a write command and/or for temporarily storing the data to be read from the storage devices in response to a read command. During the write operation the data is temporarily retained until subsequently written to one or more data storage devices. Such temporarily retained data is referred to hereinafter as “write-pending” data or “dirty data”. “Dirty” data in the volatile cache memory may be lost when power supply to the cache memory is interrupted.

The control unit notifies the host computer of the completion of the write operation when the respective data has been written to the cache memory. Accordingly, the write request is acknowledged prior to the write-pending data being stored in the permanent storage subsystem. Once the write-pending data is sent to the respective permanent storage medium, its status is changed from “write-pending” to “non-write-pending”, and the storage system relates to this data as stored at the permanent storage medium and allowed to be erased from the cache memory. Such data is referred to hereinafter as “clean data”.

However, in addition to the volatile cache memory 105 (referred to hereinafter as operational cache memory), a typical permanent storage subsystem has its internal cache memory (not illustrated in FIG. 1), e.g. each disk drive may have its own internal caching mechanism, or several disk drives may have a shared cache, etc. The internal cache memory enables optimizing the writing process in the permanent storage subsystem. Consequently, for a certain period of time (up to several seconds), the “clean” data is not really stored in a non-volatile storage medium. If a power failure takes place precisely at that time, then the data would be lost. Moreover, since the storage system in general has no control or even knowledge of the internal caching system of the permanent storage subsystem, the data is not only lost, but its status is considered by the system as safely stored data. This may create a dangerous situation of false or inconsistent data retrieval after recovery from the power failure. As known in the art, the danger of false or inconsistent data retrieval may be avoided by working in a “write through” mode, i.e., without implementing internal caching in the permanent storage subsystem. However, the “write through” mode may seriously affect the performance of the disk drives and hence is less applicable for mass-storage systems and, especially, for enterprise storage systems.

Certain embodiments of the present invention are applicable to the above described architecture of a computer system. However, the invention is not bound by the specific architecture, equivalent and/or modified functionality may be consolidated or divided in another manner and may be implemented in any appropriate combination of software, firmware and hardware. Those versed in the art will readily appreciate that the invention is, likewise, applicable to any computer system and any storage architecture implementing cache-based writing operations. In different embodiments of the invention the functional blocks and/or parts thereof may be placed in a single or in multiple geographical locations (including duplication for high-availability); operative connections between the blocks and/or within the blocks may be implemented directly or indirectly, including remote connection. The connection may be provided via Wire-line, Wireless, cable, Internet, Intranet, power, satellite or other networks and/or using any appropriate communication standard, system and/or protocol and variants or evolution thereof.

As further illustrated in FIG. 1, an uninterruptible power supply (UPS) 106, also known as a battery back-up, is operatively coupled to the storage control unit 103 so as to keep “dirty” data in the operational cache memory during a certain period of time. The UPS is also operatively coupled to the permanent storage subsystem 104 so as to enable a safe completion of writing the “clean” data from the internal cache of the permanent storage subsystem to the non-volatile storage medium. Such a known in the art approach of backing-up the powering of the permanent storage subsystem leads to increased cost of the storage system, as the UPS powering has to be provided to every disk drive and/or other parts of the permanent storage subsystems storing important information.

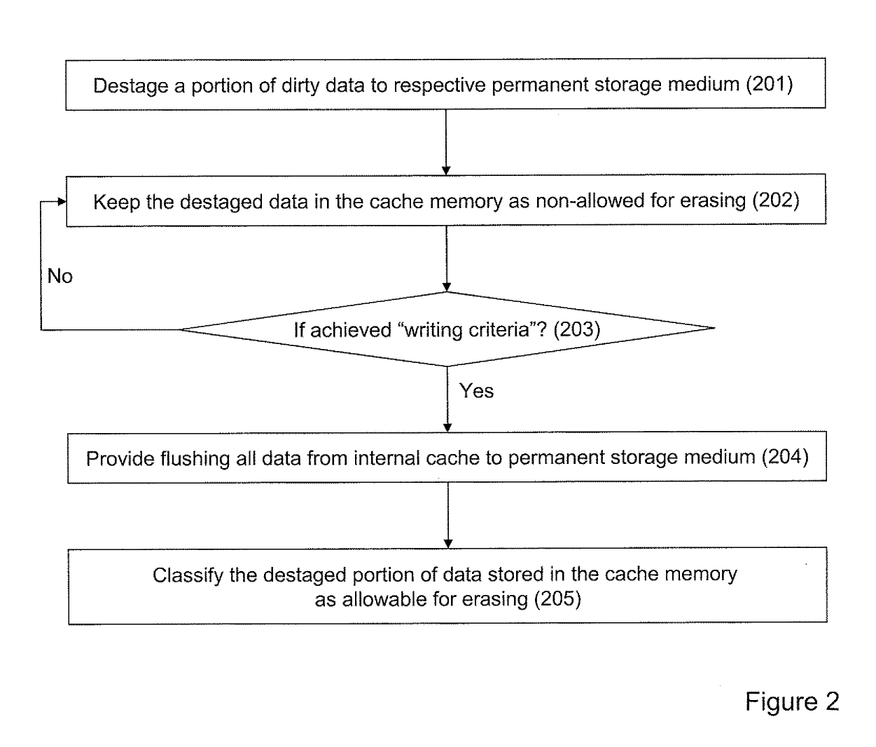

Referring to FIG. 2, there is illustrated a generalized flowchart of operating the storage system in accordance with certain embodiments of the present invention.

The “dirty” data temporarily stored in the operational cache memory are pending to be written to the permanent storage medium. This writing is provided in accordance with a “destage criterion”. The “destage criterion” is known in the Prior Art and characterizes the terms of assigning the “dirty” data or part thereof for destaging to the permanent storage subsystem. The “destage criterion” may correspond to a maximum amount of “dirty” data allowed in the operational cache memory and, by way of non-limiting example, may be defined as a threshold amount of “dirty data” (e.g. in a ratio to an entire volume of the cache memory, to a volume of cache memory assigned to a certain storage device, etc.) or as any other appropriate criterion for handling write-pending data in a cache memory. Accordingly, the storage control unit determines whether or not the amount of “dirty” data in the operational cache memory exceeds a threshold value and, if the determination is that this threshold value has been exceeded, enables writing (201) the “dirty” data or a portion thereof to the respective permanent storage media.

However, as was detailed with reference to FIG. 1, acknowledgement of writing the data to the permanent storage subsystem does not necessarily mean that the data has been actually written at the non-volatile storage medium. In contrast to known solutions, when destaging the “dirty” data is automatically accomplished by classifying the destaged portion as “clean” data allowable for erasing, in accordance with certain embodiments of the present invention the destaged portion of data is stored in the operational cache memory whilst being classified as non-allowable for erasing (202)

Such data are referred to hereinafter as “washed” data. The “washed” data are kept in the operational cache memory in accordance with a predefined “writing criterion”. The “writing criterion” may correspond to a maximum amount of “washed” data allowed in the cache and, by way of non-limiting example, may be defined as a threshold amount of “washed” data in ratio (by way of non-limiting example, 5-10%) to an entire volume of the cache memory, or to a volume of cache memory assigned to a certain storage device, disk(s), disk array(s), logical volumes, or otherwise. Alternatively or additionally, the “writing criterion” may be associated with the “destage criterion” as, for example, a ratio between the amount of “washed” data and the threshold value of “dirty” data stored in the cache. The “writing criteria” may further depend, by way of non-limiting example, upon a total amount of cache storage space (e.g. percentage of allowed “washed” data may depend on the cache capacity) and/or upon a percentage of “washed” data allowed out of the total amount of data stored in the cache and/or upon a percentage of “washed” data together with “dirty” data allowed out of the total amount of data stored in the cache and/or upon properties of respective storage devices or parts thereof. Alternatively or additionally, the “writing criterion” may correspond to certain predefined events, for example, events related to receiving indication of expected power problems, events related to receiving indication of a communication failure (e.g. for communication between the storage control unit and a respective battery back-up), etc.

The “writing criterion” may be further configurable. By way of non-limiting example, different values of the “writing criterion” may be predefined in a scheduled manner so as to be adapted to a scheduled exploitation of the storage system (e.g. different “writing criterion” may be scheduled for special night-hour maintenance activities, for week-end activities, etc.). By way of additional or alternative non-limiting example, the “writing criterion” may be configurable by the storage control unit responsive to indicating one or more predefined events. Such an indication may result from recognition of the events by the control unit or may be received from an external source. For example, responsive to recognition of overall cache overload and/or overload of certain types of traffic (e.g. random I/Os), the storage control unit may decrease the “writing criterion” in accordance with predefined rules. Optionally, the configuring may be provided with the help of learning algorithms.

The “writing criterion” shall be defined in a manner enabling that the maximum amounts of “washed” data together with “dirty” data do not exceed a predefined portion (by way of non-limiting example 70-80%) of maximal cache volume allowed for a writing operation. The storage control unit shall be further configured in a manner enabling that the portion of dirty data to be written to the permanent storage media upon achieving the “destage criterion” does not exceed the maximum amount of “washed” data allowed in the cache memory. Those versed in the art will readily appreciate that although the configuration of “writing criterion” may depend on the “destage criterion”, the storage control unit operates with regard to the “writing criterion” independently of the “destage criterion” unless specifically stated otherwise.

The storage control unit determines (203) if “writing criteria” is achieved, and if Yes, enables flushing (204) the destaged data from the internal cache memory of the permanent storage subsystem to non-volatile storage medium in accordance with the configuration of the “writing criterion”, thus ensuring safely storing of the destaged data. Such flushing may be enabled, by way of non-limiting example, by sending a “SYNCH” command to the permanent storage subsystem and/or parts thereof in accordance with the configuration of the “writing criterion”. The SYNCH command may be, for example, a standard SCSI command that flushes respective data from the disk's internal cache to respective non-volatile storage medium. In certain embodiments of the invention the “writing criterion” may be configured globally with respect to all non-volatile medium in the permanent storage subsystem. In such case all data in the internal cache will be flushed to the respective non-volatile storage medium. In other embodiments of the present invention the “writing criterion” may comprise separate sub-criteria with respect to data destaged to different parts of the permanent storage subsystem (e.g. separate logical volumes, disks, storage devices, etc. or groups thereof). In such cases, upon achieving the “writing criterion” with respect to data destaged to a certain part of the permanent storage medium (i.e. achieving respective sub-criterion), the SYNCH command will be sent for flushing data corresponding to the respective storage medium, while the rest of the data will be kept in the internal cache until receiving respective SYNCH command from the storage control unit or writing to the non-volatile medium as a part of a regular storage process.

Upon receiving an acknowledgement of performing the flushing, the controller provides a command to re-classify (205) the respective “washed” data stored in the operational cache memory as allowable for erasing (“clean” data). If the flushing command has been provided (and/or acknowledgement has been received) with respect to a part of the destaged data, only the respective portion of “washed” data will be re-classified as “clean” data. Optionally, the “clean” data may be further moved to a special portion of the operational cache memory adapted for storing the clean data.

Receiving the acknowledgement may take a certain time ΔT (typically less than 1 second) after performing the flushing. Data destaged during ΔT time interval is not safely stored in the non-volatile storage medium. In certain embodiments of the invention the controller may be configured to pause the destage operations for the period between sending the flushing command and receiving the acknowledgement. Alternatively, the “washed” data destaged after sending the flushing command, may be provided with special marking preventing this data to be classified as “clean” data upon receiving the acknowledgement. This special marking may be removed after next SYNCH command and respective further classifying this “washed” data as “clean” data.

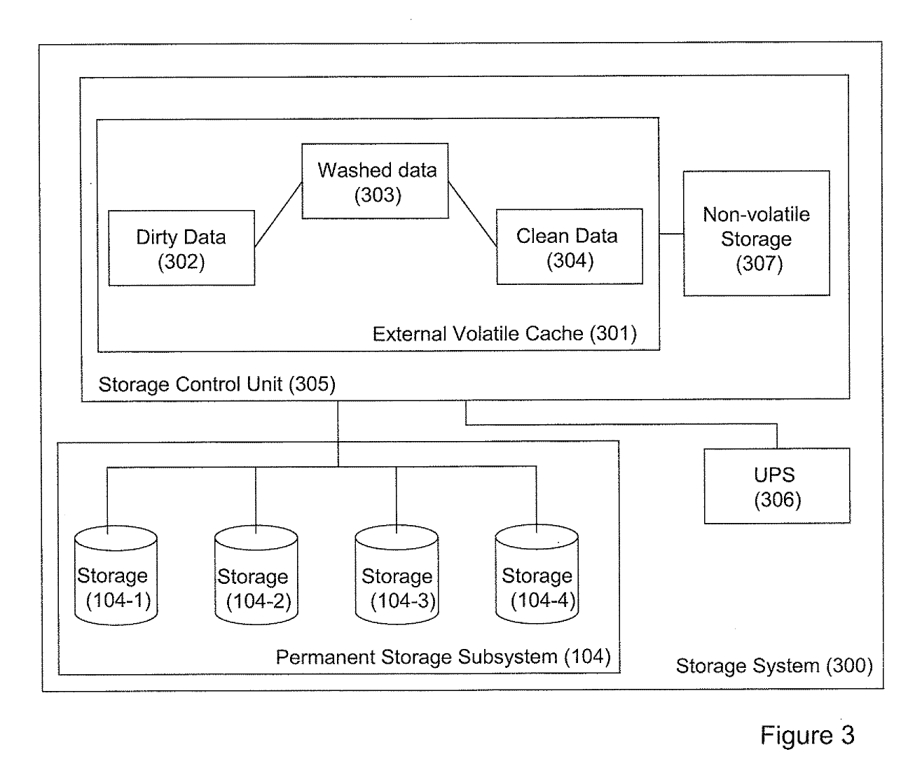

Referring to FIG. 3, there is illustrated a schematic block diagram of the storage system 300 in accordance with certain embodiments of the present invention. The storage system comprises a permanent storage subsystem 104 operatively coupled to a storage control unit 305 and to a volatile operational cache memory 301. The cache memory 301 is external with respect to the permanent storage subsystem. By way of non-limiting example, the operational cache memory 301 may constitute a part of the storage control unit (as illustrated) or, alternatively, may be operatively connected to the storage control unit and to the permanent storage subsystem and constitute a part of a device external to the storage system and operatively connected thereto (e.g. a compression appliance, an encryption appliance, etc.). The cache memory 301 is configured, responsive to commands of the storage control unit, to cache “dirty” data 302 pending to be written to the permanent storage subsystem 104, and to enable writing the “dirty” data or part thereof to the permanent storage subsystem in accordance with the “destage criterion” as has been detailed with reference to FIG. 2. In accordance with certain embodiments of the present invention, the operational cache memory is further configured to cache the “washed” data 303 destaged to the permanent storage subsystem, whilst keeping this data as non-erasable. The operational cache memory is configured, upon achieving the “writing criterion” detailed with reference to FIG. 2, to facilitate reclassification of the “washed” data into the “clean” data 304, i.e. to cache, subsequently, said data as erasable data written to the permanent storage medium.

The storage control unit 305 is configured to manage the “dirty” data, “washed” data and the “clean” data in the operational cache memory 301 as required to enable the operations detailed with reference to FIG. 2. The storage control unit is further configured to determine achievement of “writing criterion”, to provide, upon achieving, flushing command(s) to the permanent storage subsystem, to receive respective acknowledgements and to act accordingly.

In accordance with certain embodiments of the present invention, the storage control unit 305 is operatively coupled to a UPS 306 allowing, in a case of power failure, continued operation of the control unit and the operational cache memory for a certain period of time.

During this period of time, the storage control unit enables safely storing “dirty” data and “washed” data in a non-volatile data storage unit 307 operatively coupled to the volatile operational cache memory 301, whereas the “clean” data have been already safely stored in the non-volatile storage medium of the permanent storage subsystem. The non-volatile data storage unit 307 may be implemented, by way of non-limiting example, as a non-volatile cache memory, flash memory, disk drive(s), etc., located within the storage control unit or externally. If the non-volatile storage unit 307 and/or the operational cache memory 301 are located externally to the storage control unit, they shall be also powered by a UPS at least for the period of writing the “washed” data and “dirty” data for storage. Those versed in the art will readily appreciate that the invention is not limited by UPS and, likewise, applicable to any other powering back-up system enabling powering of the storage control unit, the operational cache memory and the non-volatile storage unit at least for the period of writing the “washed” data and “dirty” data for storage.

When the power of the storage system is recovered, the storage control unit enables retrieving “dirty” data and “washed” data saved in the non-volatile data storage unit 307 to the operational cache 301, classification of this data as “write-pending data” and further destaging the recovered data to the permanent storage subsystem in accordance with the “destage criterion”. The “destage criterion” may have special configuration for a case of recovery. By way of non-limiting example, such configuration may be “destage all write-pending data after power recovery”.

A part of data destaged prior to the power failure and lost from the internal cache because of the power failure will be correctly recovered after destaging formerly “washed” data recovered from the non-volatile data storage unit 307, and eventually written to disk. A respective part of data successfully stored in the non-volatile storage medium of the permanent storage subsystem prior to the power failure will be re-written after destaging the recovered data as in a routine I/O process.

Thus, in contrast to the Prior Art, in accordance with certain embodiments of the present invention, there is no need in protecting the permanent storage subsystem 104 with internal cache memory against a power failure, as all destaged data are safely stored in the non-volatile memory external to the permanent storage subsystem.

By way of non-limiting example, the capacity of the volatile operational cache memory 301 may be 2 to 4 magnitude order lower than the capacity of permanent storage subsystem 104; the capacity of the non-volatile storage unit 307 shall be not less than the capacity of the volatile operational cache memory 301. For example, the permanent storage subsystem 104 may have a capacity of 800 TB and be constituted by SATA disks with 2 TB capacity. The respective volatile operational cache memory 301 may be about 100 GB and the non-volatile storage unit 307 may be constituted by four flash memories, each one of 32 GB. A single UPS of 3-5 kW may be enough for this system as, in accordance with certain embodiments of the invention, there is no need to provide the permanent storage subsystem with a back-up powering to enable data integrity in case of an emergency shutdown.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present invention.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

Those skilled in the art will readily appreciate that various modifications and changes can be applied to the embodiments of the invention as hereinbefore described without departing from its scope, defined in and by the appended claims.

1. A storage system comprising:
a permanent storage subsystem comprising a first cache memory and a non-volatile storage medium, and a storage control unit operatively coupled to said subsystem and to a second cache memory operable to cache “dirty” data pending to be written to the permanent storage subsystem and to enable, responsive to at least one command by the control storage unit, destaging said “dirty” data or part thereof to the permanent storage subsystem;
wherein the second cache memory is further operable to cache data destaged to the permanent, storage subsystem whilst keeping this data as non-erasable thus giving rise to “washed” data, and, responsive to at least one command by the storage control unit, to facilitate reclassification of the “washed” data or part thereof into erasable data thus giving rise to “clean” data;
wherein the storage control unit is operable to determine achievement of a “writing criterion”, to provide, upon achieving, at least one command to the permanent storage subsystem requiring flushing destaged data or part thereof from the first cache memory to the non-volatile storage medium, and to provide at least one command to the second cache memory requiring reclassification of the “washed” data or a respective part thereof into the “clean” data, and
wherein the storage control unit is further operable to configure the “writing criterion” responsive to indicating one or more predefined events during an operation of the storage system.

2. The storage system of claim 1 wherein the storage control unit is operable to decrease the “writing criterion” in response to recognizing at least one event selected from a group comprising overall overload of the second cache memory and overload of certain types of requests recognized in the second cache memory.

3. The storage system of claim 1 wherein the storage control unit is operable to configure the “writing criterion” in accordance with a predefined schedule so as to be adapted to a scheduled exploitation of the storage system.

4. The storage system of claim 1 wherein the storage control unit is operable to configure the “writing criterion” responsive to one or more predefined events selected from a group comprising events related to receiving indication of expected power problems and events related to receiving indication of a communication failure between one or more elements of the storage system.

5. The storage system of claim 1 wherein the “writing criterion” corresponds to a maximum amount of “washed” data allowed in the cache.

6. The storage system of claim 1 wherein the “writing criterion” corresponds to a ratio between a threshold amount of “washed” data and entire volume of the second cache memory.

7. The storage system of claim 1 wherein the “writing criterion” corresponds to a ratio between a threshold amount of “washed” data and a volume of the second cache memory assigned to a certain part of the permanent storage subsystem.

8. The storage system of claim 1 wherein the “writing criterion” comprises at least one sub-criterion with respect to data destaged to a certain part of the permanent storage subsystem, and the storage control unit is further operable to provide, upon achieving said sub-criterion, at least one command to the permanent storage subsystem requiring flushing data destaged to said certain part of the permanent storage subsystem, and to provide at least one command to the second cache memory requiring reclassification of a portion of “washed” data into the “clean” data, said portion corresponding to data destaged to said certain part of the permanent storage subsystem.

9. The storage system of claim 1 wherein the storage control unit is further operable to receive an acknowledgement from the permanent storage subsystem of successful storing the flushed data, and to provide to the second cache memory at least one command requiring reclassification of the “washed” data or a respective part thereof into the “clean” data responsive to said acknowledgement.

10. A storage control unit operable to control I/O operations to a permanent storage subsystem comprising a first cache memory and a non-volatile storage medium, said unit associated with a second cache memory operable to cache “dirty” data pending to be written to the permanent storage subsystem and to enable, responsive to at least one command by the control storage unit, destaging said “dirty” data or part thereof to the permanent storage subsystem,
wherein the storage control unit is further operable to determine achievement of a “writing criterion”, to provide, upon achieving, at least one command to the permanent storage subsystem requiring flushing destaged data or part thereof from the first cache memory to the non-volatile storage medium, and to provide at least one command to the second cache memory requiring reclassification of the “washed” data or respective part thereof into the “clean” data, and
wherein the storage control unit is further operable to configure the “writing criterion” responsive to indicating one or more predefined events during an operation of the storage system.

11. The storage control unit of claim 10 operable to decrease the “writing criterion” in response to recognizing at least one event selected from a group comprising overall overload of the second cache memory and overload of certain types of requests recognized in the second cache memory.

12. The storage control unit of claim 10 further operable to configure the “writing criterion” in accordance with a predefined schedule so as to be adapted to a scheduled exploitation of the storage system.

13. The storage control unit of claim 10 operable to configure the “writing criterion” responsive to one or more predefined events selected from a group comprising events related to receiving indication of expected power problems and events related to receiving indication of a communication failure between one or more elements of the storage system.

14. The storage control unit of claim 10 wherein the “writing criterion” comprises at least one sub-criterion with respect to data destaged to a certain part of the permanent storage subsystem, and the storage control unit is further operable to provide, upon achieving said sub-criterion, at least one command to the permanent storage subsystem requiring flushing data destaged to said certain part of the permanent storage subsystem, and to provide at least one command to the second cache memory requiring reclassification of a portion of “washed” data into the “clean” data, said portion corresponding to data destaged to said certain part of the permanent storage subsystem.

15. The storage control unit of claim 10 further operable to receive an acknowledgement from the permanent storage subsystem of successful storing the flushed data, and to provide to the volatile cache memory at least one command requiring reclassification of the “washed” data or a respective part thereof into the “clean” data responsive to said acknowledgement.

16. A method of operating a storage system comprising a permanent storage subsystem with an first cache memory and a non-volatile storage medium, a storage control unit and a second cache memory, the method comprising:
(a) caching in the second cache memory “dirty” data pending to be written to the permanent storage subsystem;
(b) destaging “dirty” data or part thereof from the second cache memory to the permanent storage subsystem,
(c) storing the data destaged to the permanent storage subsystem also in the second cache memory whilst keeping this data as non-erasable, thus giving rise to “washed” data;
(d) determining achievement of a “writing criterion”;
(e) responsive to achieving the “writing criterion”, flushing destaged data or part thereof from the first cache memory to the non-volatile storage medium; and
(f) reclassifying respective “washed” data stored in the second cache memory into erasable data;
wherein the “writing criterion” is configurable during the operating of the storage system responsive to indicating one or more predefined events.

17. The method of claim 16 further comprising decreasing the “writing criterion” in response to recognizing at least one event selected from a group comprising overall overload of the second cache memory and overload of certain types of requests recognized in the second cache memory.

18. The method of claim 16 wherein the “writing criterion” is configurable in accordance with a predefined schedule and/or responsive to one or more predefined events selected from a group comprising events related to receiving indication of expected power problems and events related to receiving indication of a communication failure between one or more elements of the storage system.

19. The method of claim 16
wherein the “writing criterion” comprises at least one sub-criterion with respect to data destaged to a certain part of the permanent storage subsystem,
wherein said flushing data is provided upon achieving said sub-criterion with respect to data destaged to said certain part of the permanent storage subsystem while keeping the rest of the data in the first cache; and
wherein said reclassifying is provided with respect to a portion of “washed” data corresponding to data destaged to said certain part of the permanent storage subsystem.

20. The method of claim 16 further comprising receiving an acknowledgement from the permanent storage subsystem of successful storing the flushed data, wherein reclassifying respective “washed” data stored in the volatile cache memory into erasable data is provided responsive to said acknowledgement.

21. The method of claim 16 further comprising storing, in the event of a power failure, “dirty” data and “washed” data in a non-volatile data storage unit external to the permanent storage subsystem and operatively coupled to the second cache memory, thus giving rise to “saved” data; retrieving, upon power recovery, said “saved” data from the non-volatile data storage unit to the second cache memory, classifying said “saved” data as “dirty” data, and further destaging said data to the permanent storage subsystem.

22. A computer program comprising computer program code means for performing the methods of claim 16 when said program is run on a computer.

23. A computer program as claimed in claim 22 embodied on a computer readable medium.
